(19) United States
(12) Patent Application Publication
(10) Pub. No.: US 2013/0100287 A1
(43) Pub. Date: Apr. 25, 2013

(54) Blind Spot Detection System and Blind Spot Detection Method Thereof

(71) Applicants: Chun-Liang Chien, Pingzhen City (TW); Chih-Cheng Tu, Zhubei City (TW); Chih-Woei Tsai, Tainan City (TW)

(72) Inventors: Chun-Liang Chien, Pingzhen City (TW); Chih-Cheng Tu, Zhubei City (TW); Chih-Woei Tsai, Tainan City (TW)

(73) Assignee: ALTEK AUTOTRONICS CORP., Hsinchu (TW)

(21) Appl. No.: 13/344,159

(22) Filed: Jan. 5, 2012

(30) Foreign Application Priority Data
Oct. 25, 2011 (TW) 100138571

(51) Int. Cl. H04N 7/18

(52) U.S. Cl. 348/148; 348/E07.085

(57) ABSTRACT

A blind spot detection system and method thereof applicable to a transportation vehicle. The blind spot detection system comprises a plurality of detection modules, a processing module and a display module. When the transportation vehicle moves at a speed less than a predetermined speed or at a stop moving state, each detection module is used to detect a plurality of blind spot images around the transportation vehicle. The processing module is connected to each detection module and used to receive the plurality of blind spot images and execute an image processing for detecting and identifying a moving object in the plurality of blind spot images, and to generate a mark pattern corresponding to the moving object. The display module is connected to the processing module and used to display the plurality of blind spot images and the mark pattern in a blind spot display mode.

### CROSS-REFERENCE TO RELATED APPLICATION

This application claims the benefit of priority to Taiwan Patent Application No. 100138571, filed on Oct. 25, 2011, in the Taiwan Intellectual Property Office, the disclosure of which is incorporated herein in its entirety by reference.

### FIELD OF THE INVENTION

The present invention relates to a blind spot detection system and a blind spot detection method thereof, in particular to the blind spot detection system and method for detecting a blind spot when a car is moving at a speed less than 10 Km/h, or situated at a stopping state, or even when an ignition switch of the car is switched off.

### BACKGROUND OF THE INVENTION

Most blind spot detection (BSD) systems are disposed on both left and right sides of a car, such as both ends of a rear view mirror or both sides of a bumper at the rear of the car. The BSD system is mainly used for detecting the distance and speed of a moving object at a left or right blind spot of the car, and further performs an object tracing algorithm to recognize a car (or a moving object) appearing at the left or right blind spot by an image processing method. If the car appearing at the blind spot matches a target characteristic, such as the size being greater than a predetermined range, then a warning signal including light signal, an image or a sound can be outputted to remind a driver. Such image processing technology is provided for detecting blind spots around the car to avoid possible collisions from both sides, so as to avoid car accidents caused by the blind spots.

Although the BSD systems such as a blind spot information system (BLIS) provided in current market can achieve the aforementioned detection and warning effects, but the BUS is started only when the car is moving at a speed over 10 Km/h. In a crowded environment filled with many cars, accidents may occur even if the car remains still. For example, an accident may occur when the car is parked and the driver opens a car door without noticing other vehicle coming from behind, the driver and the other person involved may be injured. Therefore, the BSD system should not be used only while the car is moving in high speed, but it should also be used when the car is stopped or parked (or the car remains still), so as to reduce car accidents and protect the safety of pedestrians effectively.

### SUMMARY OF THE INVENTION

In view of the aforementioned problem of the prior art, it is a primary objective of the present invention to provide a blind spot detection system and a blind spot detection method thereof to overcome the problem of the prior art that can start the blind spot detection only if the car is moving at a speed greater than a predetermined speed.

To achieve the aforementioned objective, the present invention provides a blind spot detection system applicable to a transportation vehicle, comprising a plurality of detection modules, a processing module and a display module. The plurality of detection modules are disposed on a left side and a right side of the transportation vehicle respectively, and each detection module captures a plurality of blind spot images around the transportation vehicle when the transportation vehicle is moving at a speed less than a predetermined speed or situated at a stop moving state. The processing module is electrically coupled to each detection module for receiving the plurality of blind spot images and performing an image processing to detect and recognize a moving object in the plurality of blind spot images, and generating a mark pattern corresponding to the moving object. The display module is electrically coupled to the processing module to display the plurality of blind spot images and the mark pattern in a blind spot display mode.

Preferably, the predetermined speed is less than 10 kilometers per hour.

Preferably, each of the detection module, the processing module and the display module is still in an activated state after the ignition switch of the transportation vehicle is switched off.

Preferably, when the car door of the transportation vehicle is closed and an anti-burglar device is turned on, and each of the detection module, the processing module and the display module is turned off.

Preferably, the blind spot detection system of the present invention further comprises a sensing module, detecting whether there is a driver or a passenger in the transportation vehicle when the transportation vehicle is situated at a stop moving state; if yes, then the plurality detection modules will be turned off, and the display module is switched from the blind spot display mode to a multimedia display mode.

Preferably, the blind spot images include a left blind spot image and a right blind spot image, and the processing module is provided for adjusting an algorithm of an operation efficacy of the image processing of the left blind spot image or right blind spot image according to a steering wheel helm angle or turn signal light information of the transportation vehicle.

To achieve the aforementioned objective, the present invention further provides a blind spot detection system, applicable to a transportation vehicle, comprising means for capturing a plurality of blind spot images around the transportation vehicle when the transportation vehicle is moving at a speed less than a predetermined speed or situated at a stop moving state or when an ignition of the transportation vehicle is switched off; means for detecting and recognizing a moving object in the plurality of blind spot images, and generating a mark pattern corresponding to the moving object; means for displaying the plurality of blind spot images and the mark pattern in a blind spot display mode; and means for reminding a driver about the moving object in the plurality of blind spot images by using sound information.

To achieve the aforementioned objective, the present invention further provides a blind spot detection method applicable to a transportation vehicle, comprising the following steps. An image processing step is executed to perform an image processing of a left blind spot image and a right blind spot image to detect and recognize a moving object in the left blind spot image or the right blind spot image when the transportation vehicle is moving at a speed less than a predetermined speed or situated at a stop moving state or when an ignition of the transportation vehicle is switched off, and generating a mark pattern corresponding to the moving object; and a display step is executed to display the left blind spot image or the right blind spot image and the mark pattern in a blind spot display mode.

In summation, the blind spot detection system and method in accordance with the present invention have one or more of the following advantages:

(1) The blind spot detection system and method keep operating for a period of time after the car is moving at a speed less than 10 Km/h, or situated at a car stopping state, or even after the driver switches off the ignition switch of the car. The blind spot detection system and method will stop operating, until the driver gets off the car, closes the car door, and starts an anti-burglar device. Therefore, the invention not only detects the blind spots around the car to enhance the driving safety when the car is moving, but also detects the blind spots while the car is not moving, so as to prevent the driver from being hit by a car coming from behind or injuring a driver of a car coming from behind when the driver opens the car door carelessly.

(2) The blind spot detection system and method can adjust the computing performance of the image processing automatically according to the steering direction made by the driver to enhance the image recognition percentage and reduce detection errors.

### BRIEF DESCRIPTION OF THE DRAWINGS

FIG. 1 is a schematic view of a blind spot detection system in accordance with a first preferred embodiment of the present invention.

FIG. 2 is a flow chart of a blind spot detection method in accordance with the first preferred embodiment of the present invention.

FIG. 3 is a schematic view of a blind spot detection system in accordance with a second preferred embodiment of the present invention.

FIG. 4 is a schematic view of a blind spot detection system in accordance with a third preferred embodiment of the present invention.

FIG. 5 is a flow chart of a blind spot detection method in accordance with the third preferred embodiment of the present invention.

FIG. 6 is a schematic view of a blind spot detection system in accordance with a fourth preferred embodiment of the present invention.

### DESCRIPTION OF THE PREFERRED EMBODIMENTS

The technical characteristics of the present invention will become apparent with the detailed description of the preferred embodiments accompanied with the illustration of related drawings as follows. It is noteworthy to point out that same numerals are used for representing respective elements in the description of the following preferred embodiments.

The blind spot detection system and the blind spot detection method of the present invention are applicable to a transportation vehicle such as a car, a motorcycle, a bicycle or any transportation means used for carrying passengers or goods, but the scope of applicability is not limited to the aforementioned transportation vehicles only.

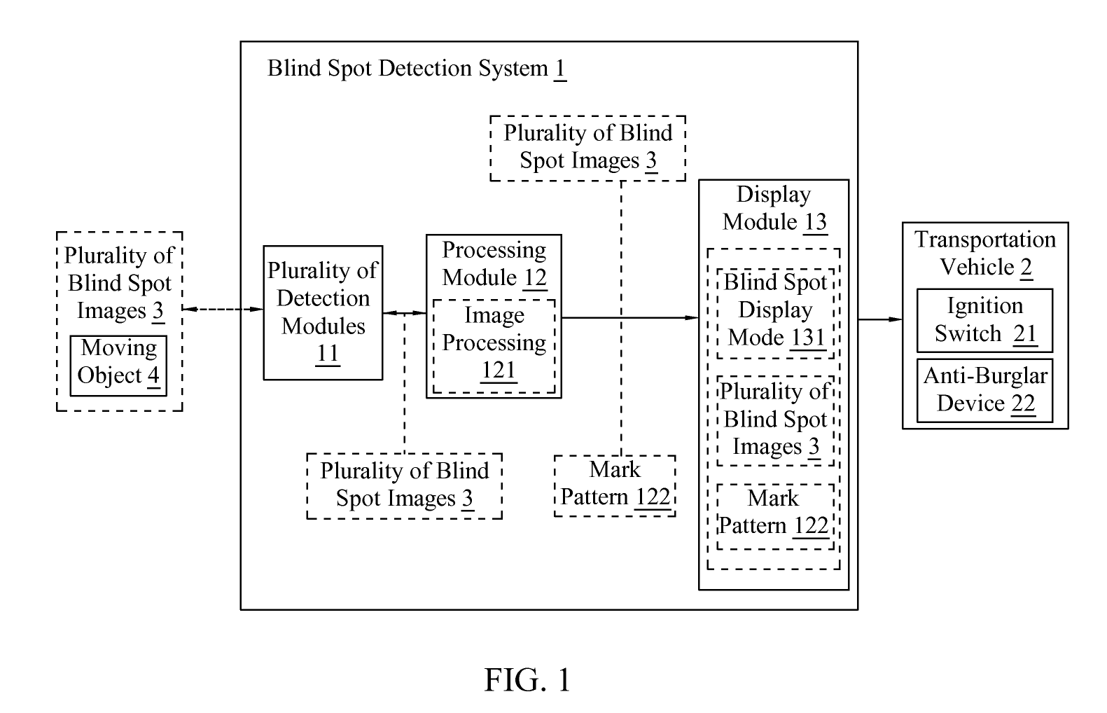

With reference to FIG. 1 for a schematic view of a blind spot detection system in accordance with the first preferred embodiment of the present invention, the blind spot detection system 1 can be disposed on a device of a transportation vehicle 2, wherein the transportation vehicle 2 can be a car, a motorcycle or a bicycle. The blind spot detection system 1 comprises a plurality of detection modules 11, a processing module 12 and a display module 13. The processing module 12 is electrically coupled to the plurality of detection modules 11 and the display module 13. The plurality of detection modules 11 can be cameras. The present invention is not limited to cameras only, they can also be ultrasonic sensors, infrared sensors, and radar sensors for sensing an object. The detection modules 11 can be disposed on both left and right sides of the transportation vehicle 2 respectively, for example, the detection modules is disposed on rear view mirror frames of both left and right sides of the transportation vehicle 2 respectively, or disposed on both ends of a rear bumper of the transportation vehicle 2, but the actual installation position is not limited to aforementioned positions only. The processing module 12 can be a computing device of the transportation vehicle 2 for performing various algorithms to process each type of image information. The display module 13 can be a central control display of the transportation vehicle 2 for displaying various information such as multimedia information of TV programs and global positioning systems (GPS) and displaying the blind spot images. Besides the central control display, the display module 13 can also be a head up display (HUD) or a display device integrated with the rear view mirror of the transportation vehicle 2. This arrangement is provided for illustrating the present invention only, but not intended for limiting the scope of the invention.

In the first preferred embodiment, the blind spot detection system 1 is turned on when the transportation vehicle 2 is moving at a speed less than a predetermined speed or situated at a stop moving state, wherein each detection module 11 is provided for detecting a plurality of blind spot images 3 around the transportation vehicle 2. Since each detection module 11 is disposed on both left and right sides of the transportation vehicle 2, therefore the blind spot images 3 can be divided into a left blind spot image and right a blind spot image. The processing module 12 is provided for receiving the plurality of blind spot images 3 and performing an image processing 121 to detect and recognize whether there is a moving object in the plurality of blind spot images 3. A mark pattern 122 corresponding to the moving object 4 will be generated if the processing module 12 recognizes that there is a moving object in the plurality of blind spot images 3 and the moving object 4 matches a target characteristic such as a size thereof being greater than a predetermined volume, and the display module 13 will display the plurality of blind spot images 3 and the mark pattern 122 in a blind spot display mode 131, or will display the speed of the moving object. In the embodiment, the predetermined speed is less than 10 Km/h, but the blind spot detection system 1 of the present invention can also perform detections when the transportation vehicle 2 is moving at a speed over 10 Km/h. In other words, the blind spot detection system 1 can perform detections at any speed (including zero speed). It is noteworthy to point out that this preferred embodiment is provided for illustrating the technical characteristics of the present invention only, but not intended for limiting the scope of the invention.

In the embodiment, the blind spot detection system 1 keeps performing the detection after the ignition switch 21 of the transportation vehicle 2 is switched off, and the blind spot detection system 1 is turned off when an anti-burglar device 22 is turned on. The blind spot detection system 1 can be turned on or turned off manually by the driver as needed, or automatically according to the settings of the blind spot detection system 1.

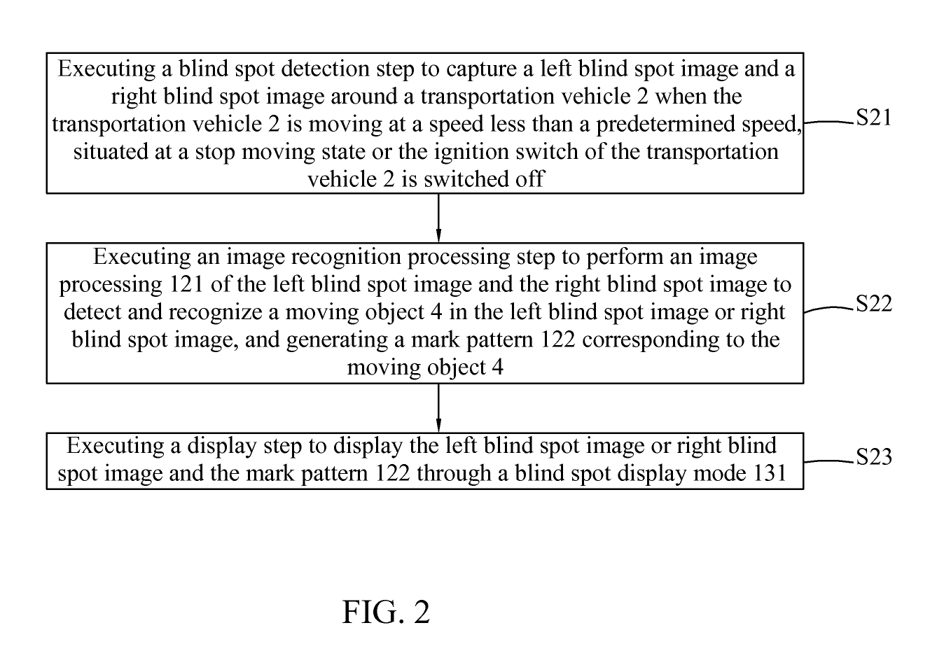

With reference to FIG. 2 for a flow chart of a blind spot detection method in accordance with the first preferred embodiment of the present invention, the blind spot detection method comprises the following steps.

S21: Executing a blind spot detection step to capture a left blind spot image and a right blind spot image around a transportation vehicle 2 when the transportation vehicle 2 is moving at a speed less than a predetermined speed, situated at a stop moving state or the ignition switch of the transportation vehicle 2 is switched off.

S22: Executing an image recognition processing step to perform an image processing 121 of the left blind spot image and the right blind spot image to detect and recognize a moving object 4 in the left blind spot image or right blind spot image, and generating a mark pattern 122 corresponding to the moving object 4.

S23: Executing a display step to display the left blind spot image or right blind spot image and the mark pattern 122 in a blind spot display mode 131.

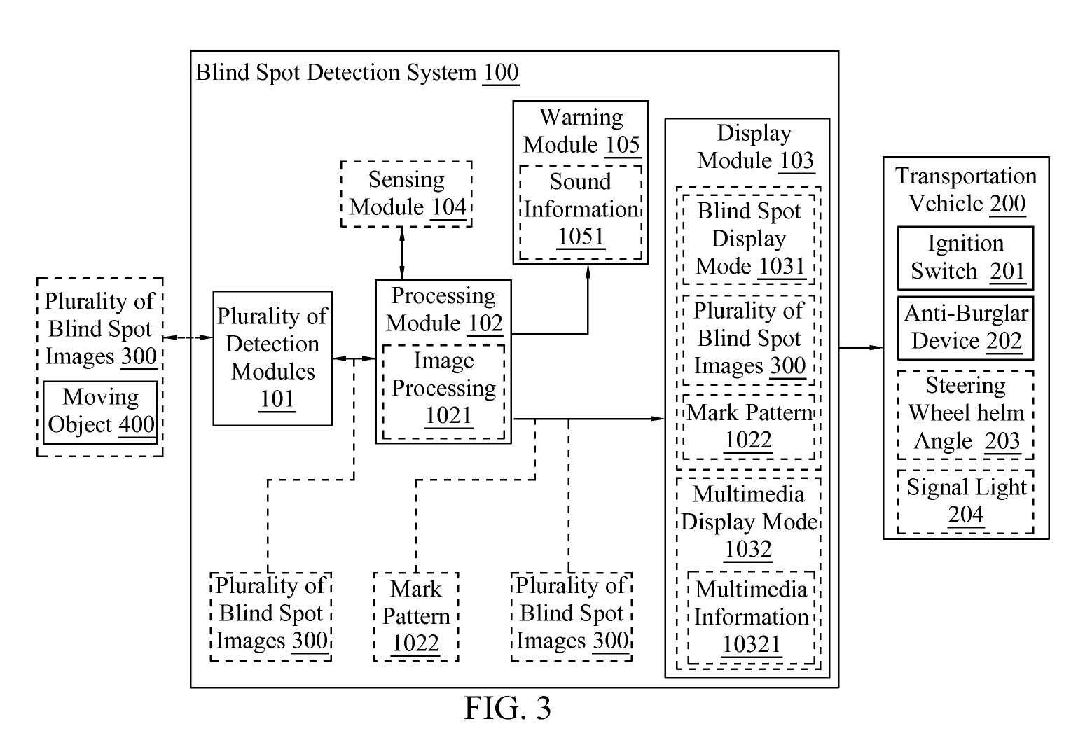

With reference to FIG. 3 for a schematic view of a blind spot detection system in accordance with the second preferred embodiment of the present invention, the blind spot detection system 100 is disposed on a transportation vehicle 200 and comprises a plurality of detection modules 101, a processing module 102, a display module 103, a sensing module 104 and a warning module 105. The processing module 102 is electrically coupled to the plurality of detection modules 101, the display module 103, the sensing module 104 and the warning module 105. Each of the detection module 101, the processing module 102 and the display module 103 is disposed on the transportation vehicle 200 in a way similar to the first preferred embodiment, and thus will not be described again. The sensing module 104 can be an infrared sensor or any other device for sensing human body heat and the sensing module 104 is disposed in the transportation vehicle 200. Preferably, the sensing module 104 is disposed in a front base of the transportation vehicle 200, but the invention is not limited to such arrangement only. The warning module 105 can be a loudspeaker, a speaker, or any device capable of producing a sound. The warning module 105 is disposed in the transportation vehicle 200 independently, or integrated with the display module 103 to remind drivers by images and sounds.

In the embodiment, the blind spot detection system 100 can be turned on when a transportation vehicle 200 is moving at a speed less than a predetermined speed, situated at a stop moving state or when an ignition switch 201 is switched off. Wherein, the predetermined speed is less than 10 Km/h or greater than 10 Km/h. The blind spot detection system 100 can be turned on automatically, or manually by a driver. Each detection module 101 captures a plurality of blind spot images 300 around the transportation vehicle 200 when the blind spot detection system 100 is in operation. Since each detection module 101 can be disposed on a left side or a right side of the transportation vehicle 200, the detection module 101 disposed at the left detection module 101 can capture a left blind spot image, and the detection module 101 disposed at the right side can capture a right blind spot image. The processing module 102 performs an image processing 1021 to detect and recognize a moving object 400 in the plurality of blind spot images 300 when the processing module 102 receives the plurality of blind spot images 300, and generates a mark pattern 1022 corresponding to the moving object 400. The processing module 102 can control the display module 103 to display the plurality of blind spot images 300 and the mark pattern 1022 in a blind spot display mode 1031 after finishing the image processing 1021, and the warning module 105 will produce sound information 1051 to remind a driver. Wherein, the display module 103 can display the sound information 1051 or information in form of figures, real images, or blinking lights.

From the description above, the sensing module 104 in the blind spot detection system 100 is turned on to detect whether there is a driver or a passenger in the transportation vehicle 200 when the transportation vehicle 200 stops moving (at zero speed, but the engine keeps running). If yes, then each detection module 101 will be turned off within a certain time, and the display module 103 will be switched from the blind spot display mode 1031 to a multimedia display mode 1032 to provide multimedia information 10321 such as TV programs. Each detection module 101 will be turned on again automatically to perform detections when the driver switches off the ignition switch 201 of the transportation vehicle 200. The detection module 101 will be turned off again until the driver gets off the transportation vehicle 200, closes the car door and turns on an anti-burglar device 202. Therefore, the blind spot detection system 100 can automatically determine whether the driver needs to turn on or off the detection function to provide necessary safety protections, and avoid producing detection warnings to disturb the driver continuously.

From the description above, the blind spot detection system 100 of the present invention can automatically adjust the sensitivity to balance, increase or decrease a computing performance or an algorithm of an image processing 1021 of the processing module 102. Since the detection modules 101 are disposed on both left and right sides of the transportation vehicle 200, therefore the detection modules 101 can capture the left blind spot image and right blind spot image respectively. The processing module 102 performs an image processing 1021 according to the left blind spot image and right blind spot image. After the processing module 102 performs the image processing 1021, the computing performance and the algorithm of the image processing 1021 can be adjusted according to each driving information of the transportation vehicle 200. In other words, the processing module 102 adjusts the computing performance and the algorithm of the image processing 1021 of the left blind spot image or the right blind spot image according to the information such as the steering wheel helm angle 203 or the signal light information 202 of the transportation vehicle 200. For example, if the driver wants to turn left turn, the processing module 102 will determine whether the transportation vehicle 200 makes a left turn according to the steering wheel helm angle 203, so that the processing module 102 will increase the computing performance of the image processing 1021 of the left blind spot image and decrease the computing performance of the image processing 1021 of the right blind spot image to enhance the left detection recognition power, so as to improve the safety and reduce the recognition error percentage effectively. Wherein, the image processing 1021 adopts an optical flow method or an underneath shadow method for the recognition. If it is necessary to increase the processing performance of the image processing 1021 of the processing module 102, a neural network algorithm or a pattern recognition algorithm can be added to improve the object recognition rate, so as to prevent alarms caused by wrong detections.

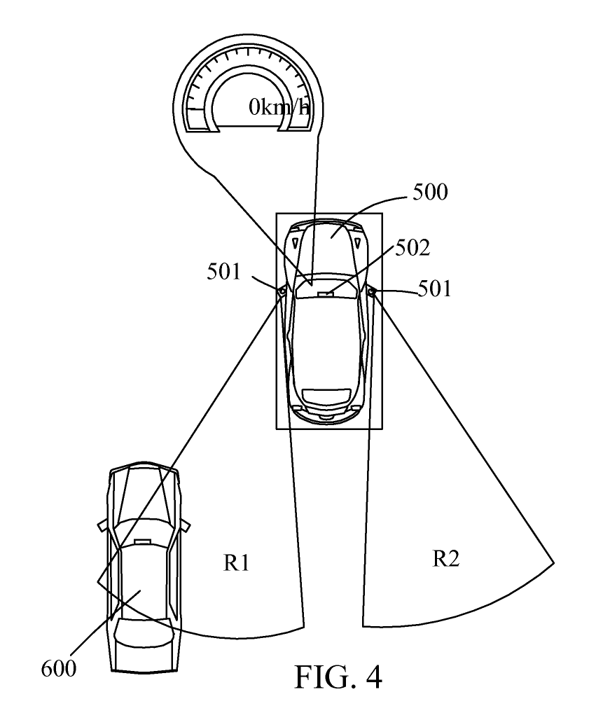

With reference to FIG. 4 for a schematic view of a blind spot detection system in accordance with the third preferred embodiment of the present invention. In the embodiment, a car 500 equipped with the blind spot detection system of the present invention is parked on a roadside. The blind spot detection system comprises a processor (which is the processing module described in the present invention), an image detector 501 (which is the detection module described in the present invention) and a central control display 502 (which is the display module of the present invention). Now, the speed of the car 500 is 0 Km/h, the engine keeps running and the ignition switch is not switched off. When the car 500 is stopped, the blind spot detection system is still operating, wherein the image detectors 501 disposed on both left and right sides of the rear view mirror of the car 500 detect the blind spots R1 and R2 around the car to perform the detection and image capturing motion. The image detector 501 transmits a blind spot image captured at the blind spot R1 or R2 to the processor, and the processor performs an image processing according to the blind spot image to recognize whether there is a moving object in the blind spot image. If the processor recognizes a moving object 600 in the blind spot image, the processor will produce a mark pattern corresponding to the moving object 600, and the central control display 502 displays the blind spot image and the mark pattern corresponding to the moving object 600 in a blind spot display mode. The central control display 502 also displays the speed of the moving object 600, and produces a sound warning to remind the driver about the safety when the driver gets off the car.

In the embodiment, after the blind spot detection system keeps detecting whether there is a driver or a passenger in the car 500 after the car 500 is stopped for a period of time. If yes, then the image detector 501 will be turn off to stop the detection and the image capturing motion of the blind spots R1 and R2, and the central control display 502 is switched from the blind spot display mode to a multimedia display mode to provide the multimedia information for the driver's view. The blind spot detection system can be turned on automatically or the driver turns on by himself to perform a detection motion when the car 500 starts moving or the ignition is switched off. The blind spot detection system can be turned on automatically by factory default settings of the car 500 or driver's settings. These are embodiments are used for illustrating the present invention, but not intended for limiting the scope of the invention.

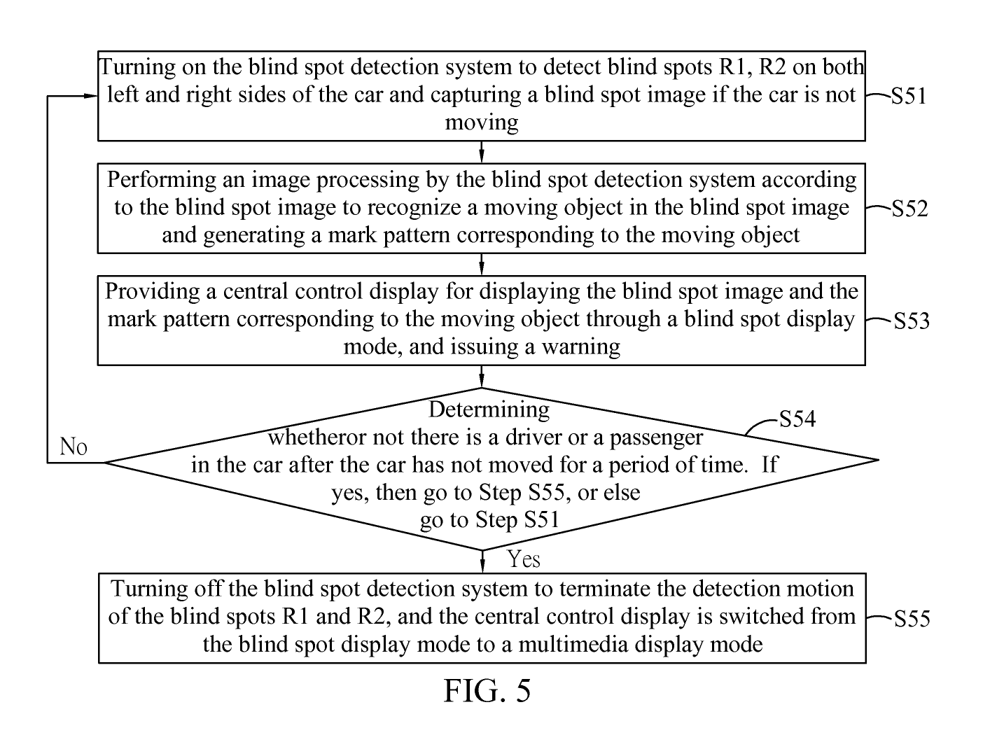

With reference to FIG. 5 for a flow chart of a blind spot detection method in accordance with the third preferred embodiment of the present invention, the blind spot detection system is applied to a car 500 for performing a detection motion while the car 500 is not moving. The blind spot detection method comprises the following steps.

S51: Turning on the blind spot detection system to detect blind spots R1, R2 on both left and right sides of the car 500 and capturing a blind spot image if the car 500 is not moving.

S52: Performing an image processing by the blind spot detection system according to the blind spot image to recognize a moving object 600 in the blind spot image and generating a mark pattern corresponding to the moving object 600.

S53: Providing a central control display 502 for displaying the blind spot image and the mark pattern corresponding to the moving object 600 in a blind spot display mode, and issuing a warning.

S54: Determining whether or not there is a driver or a passenger in the car 500 after the car 500 has not moved for a period of time. If yes, then go to Step S55, or else go to Step S51.

S55: Turning off the blind spot detection system to terminate the detection motion of the blind spots R1 and R2, and the central control display 502 is switched from the blind spot display mode to a multimedia display mode.

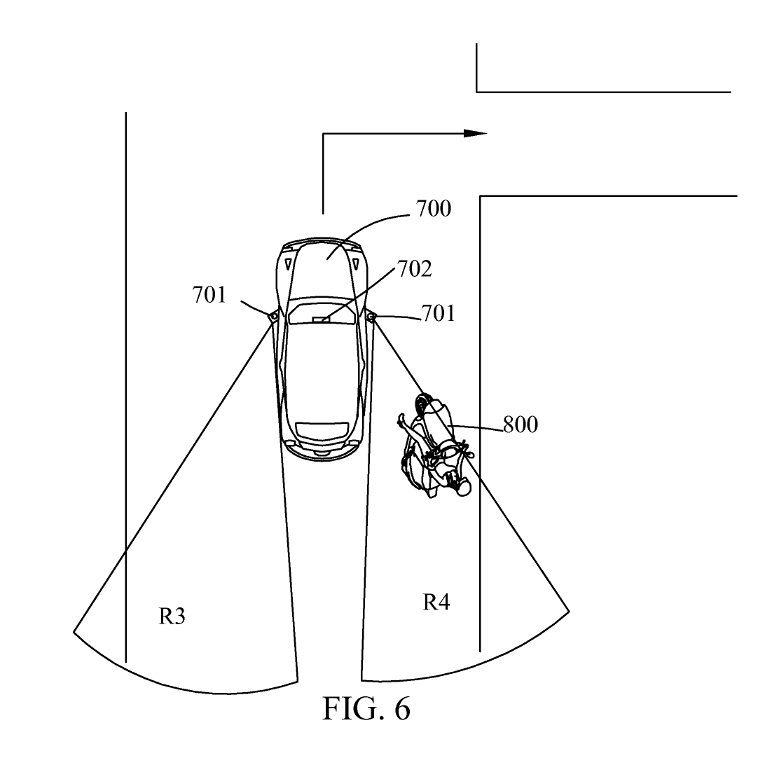

With reference to FIG. 6 for a schematic view of a blind spot detection system in accordance with the fourth preferred embodiment of the present invention. In the embodiment, a car 700 equips with the blind spot detection system, and the blind spot detection system comprises a processor, an image detector 701 and a central control display 702. The car 700 is moving at a speed less than 10 km/h on a road, and the blind spot detection system is turned on, and the image detectors 701 are disposed on the rear view mirrors on both sides of the car 700 to detect the blind spots R3 and R4, and capture a blind spot image. Wherein, the processor of the blind spot detection system will adjust a computing performance or an algorithm of the image processing of the blind spot image of the blind spot R3 or R4 according to the steering wheel helm angle or turn signal light information of the car 700 when the car 700 makes a right turn. Since the car 700 is making a right turn, therefore the processor of the blind spot detection system will increase the computing performance of the image processing of the blind spot image of the blind spot R4 from the original processing performance of three images per second to two hundred images per second, and enhance the object recognition percentage, so as to assure the accuracy of the right side detection processing, enhance the safety, and reduce the error percentage of the detection and recognition.

From the description above, if the blind spot detection system performs a detection and an image processing to recognize a moving object 800 in the blind spot R4, the central control display 702 uses a figure, a real image, a light signal or a sound to remind drivers about the moving object 800 is in the blind spot R4 or near the blind spot R4, or display the position and speed of the moving object 800 directly. Wherein, the blind spot detection system can allocate the computing performance of the image processing automatically to improve the computing performance of the right or left detection, and reduce or shut down the image computation on the other side to concentrate the high performance for the detection and recognition. The method of adjusting the computing performance of the image processing of the invention is not limited to this preferred embodiment only, but the method can be used for increasing or decreasing the computing performance as well.

In summation of the description above, the blind spot detection system and method of the present invention can be used for detecting a blind spot while a car is moving at any speed or stopped or the ignition switch is switched off within a predetermined time. Besides improving the safety of driving effectively, the present invention also prevents drivers from being hit accidentally by a car coming from behind or injuring a driver of a car coming from behind by opening the car door carelessly. In addition, the blind spot detection system can adjust the computing performance of the image processing automatically to enhance the accuracy of object recognition and reduce the detection errors.

What is claimed is:

1. A blind spot detection system, applicable to a transportation vehicle, comprising:
a plurality of detection modules, disposed on a left side and a right side of the transportation vehicle respectively, such that when the transportation vehicle is moving at a speed less than a predetermined speed or situated at a stop moving state, each detection module captures a plurality of blind spot images around the transportation vehicle;
a processing module, electrically coupled to each of the plurality of detection modules, for receiving the plurality of blind spot images and performing an image processing to detect and recognize a moving object in the plurality of blind spot images, and generate a mark pattern corresponding to the moving object; and
a display module, electrically coupled to the processing module, for displaying the plurality of blind spot images and the mark pattern in a blind spot display mode.

2. The blind spot detection system of claim 1, wherein the predetermined speed is less than 10 kilometers per hour.

3. The blind spot detection system of claim 1, wherein each of the plurality of the detection modules, the processing module and the display module are still situated at an activated state after an ignition switch of the transportation vehicle is switched off.

4. The blind spot detection system of claim 3, wherein each of the plurality of the detection modules, the processing module and the display module are turned off when a car door of the transportation vehicle is closed and an anti-burglar device is turned on.

5. The blind spot detection system of claim 1, further comprising a sensing module detecting whether there is a driver or a passenger in the transportation vehicle when the transportation vehicle is situated at the stop moving state; if yes, then the plurality detection modules are turned off, and the display module is switched from the blind spot display mode to a multimedia display mode.

6. The blind spot detection system of claim 1, wherein the plurality of blind spot images include a left blind spot image and a right blind spot image, and the processing module adjusting a computing resource or an algorithm of the image processing of the left blind spot image and the right blind spot image according to a steering wheel helm angle or a turn signal light information of the transportation vehicle.

7. A blind spot detection system, applicable to a transportation vehicle, comprising:
means for capturing a plurality of blind spot images around the transportation vehicle when the transportation vehicle is moving at a speed less than a predetermined speed or situated at a stop moving state or when an ignition switch is switched off;
means for detecting and recognizing a moving object in the plurality of blind spot images, and generating a mark pattern corresponding to the moving object;
means for displaying the plurality of blind spot images and the mark pattern in a blind spot display mode; and
means for reminding a user about the moving object in the plurality of blind spot images by sound information.

8. A blind spot detection method, applicable to a transportation vehicle, comprising the steps of:
executing a blind spot detection step to capture a left blind spot image and a right blind spot image around the transportation vehicle when the transportation vehicle is moving at a speed less than a predetermined speed or situated at a stop moving state or when an ignition switch of the transportation vehicle is switched off;
executing an image processing step to perform an image processing of the left blind spot image and the right blind spot image to detect and recognize a moving object in the left blind spot image or the right blind spot image and generate a mark pattern corresponding to the moving object; and
executing a display step, for displaying the left blind spot image or the right blind spot image and the mark pattern in a blind spot display mode.

9. The blind spot detection method of claim 8, wherein the predetermined speed is less than 10 kilometers per hour.

10. The blind spot detection method of claim 8, further comprising the step of terminating the blind spot detection step, the image processing step and the display step, when a car door of the transportation vehicle is closed and an anti-burglar device is turned on.

11. The blind spot detection method of claim 8, further comprising a step of executing a human body sensing step to detect whether there is a driver or a passenger in the transportation vehicle when the transportation vehicle is situated at the stop moving state; if yes, terminating the blind spot detection step, and switching the blind spot display mode into a multimedia display mode.

12. The blind spot detection method of claim 8, further comprising a step of adjusting computing resource or an algorithm of the image processing of the left blind spot image and the right blind spot image according to a steering wheel helm angle or turn signal light information of the transportation vehicle.
